(19) United States
(12) Patent Application Publication
(10) Pub. No.: US 2012/0023593 A1
(43) Pub. Date: Jan. 26, 2012

(54) SYSTEM AND METHOD FOR FILTERING INTERNET CONTENT & BLOCKING UNDESIRED WEBSITES BY SECURE NETWORK APPLIANCE

(76) Inventors: George PUDER, Honolulu, HI (US); Todd Kamisugi, Honolulu, HI (US)

(21) Appl. No.: 12/843,830

(22) Filed: Jul. 26, 2010

(51) Int. Cl. G06F 21/00

(52) U.S. Cl. 726/28

(57) ABSTRACT

A secure network appliance for filtering Internet websites checks each request from a user's browser against a whitelist of pre-approved websites and passes it only if it is on the whitelist. Otherwise, the request is replaced with pre-arranged content and returned as a response to the user's web browser. It can also check the port the user's request came through against an approved ports whitelist, and responses sent from the Internet against an approved websites whitelist. The network appliance is encapsulated within a secure container so that only an authorized administrator having a unique key can unlock it and access its control functions. The secure container may be formed as a separate hardware component that is physically interposed between a router and a user's computer, or as secure software that run on or operates with a network server.

### TECHNICAL FIELD

This patent application generally relates to a system and method for filtering Internet content and blocking undesired websites and, in particular, by the use of a secure network appliance.

### BACKGROUND OF INVENTION

The World Wide Web (the “Internet”) has become an integral part of daily online activity for users around the world. As the Internet expands its reach, the dangers of exposing “web surfers” and their computers have increased. These dangers may come in the forms of viruses and malware adapted to disable computers, or in the form of inappropriate or undesired explicit content. Malware designed to shut down operating systems, access information, and enable remote hacking has amounted to billions of dollars in damage and has negatively impacted the lives of countless users. For example, millions of users become victims of identity theft every year, as identity theft has become the fastest growing crime in the U.S. in recent years. Billions of dollars are stolen annually through identity theft. Inappropriate or undesired explicit content has also become a major problem for children and teenagers and their parents. Large percentages of teenagers report that they have received unwanted sexual solicitations via the Web.

There are several solutions that are currently provided to protect computer users from malware, identity theft, inappropriate content and unwanted solicitations. Most computers have security software installed with updatable virus and malware profiles, firewall rules and browser security settings intended to block undesired content or websites. With blocking type software, the user is forwarded to a blank page if a requested website is on a “blacklist”, and the contents of the blocked web page are not loaded onto the user's computer. Malicious banners and adware can be targeted for blocking, and chat room sites and other undesirable websites can be removed from view. Some software allows system administrators to create a “blacklist” directory applicable to networked computers on the system, and includes password protection so that other computer users cannot bypass or modify the list of blocked sites or load lists of unauthorized URLs or keywords.

Software programs that attempt to identify, block, quarantine, or remove viruses and malware, although effective, slow down the performance of a computer. Software using certification methods can be complex or difficult to maintain and may not be able to effectively prevent a user from logging onto bad websites, or block all spyware, adware or programs adapted to track and steal personal information. Spam, junk mail and programs designed to invade the everyday user for commercial purposes may be allowed without the proper monitoring, maintenance and updating from the user or administrator. Most software filters can be compromised.

For current security software, blacklists require constant maintenance and updating since numerous “bad” sites become available every day. As a result security updates must be uploaded frequently, becoming an inconvenience or even an annoyance when rebooting of the computer is required, and the update function itself can serve as a point of attack for unauthorized persons hacking into computers.

### SUMMARY OF INVENTION

The present invention overcomes the problem with blacklist-based security software by taking an opposite approach of permitting user access to and from websites only if the websites requested are on an approved list or “whitelist”. In addition, the whitelist-based software is contained in a locked, secure network appliance, either in physical hardware or in secure administrator-controlled server software, making it very difficult to hack.

In preferred embodiments, the secure network appliance performs a series of filtering functions for complete security. With each outgoing request for a website sent from the user's web browser, it first checks the port the user's request came through against an approved ports whitelist. If the port is not on the approved ports whitelist, the request is passed to an internal webserver where the request for content is replaced with pre-arranged content and returned as a response to the user's web browser. The secure network appliance next checks the requested website address against an approved websites whitelist. If the requested website address is not on the approved websites whitelist, the request is passed to the internal webserver where it is replaced with pre-arranged content and returned as a response to the user's web browser. The whitelist filtering function may also be performed on the receiving side from the Internet for enhanced security. If the sending website address is not on the approved websites whitelist, the response is replaced with pre-arranged content and passed as a response to the user's web browser.

In a preferred hardware embodiment, the secure network appliance is a separate hardware component that is physically interposed in a location linking a router to a port of a user's computer. The appliance may employ standard types of Ethernet cables with jacks that have a key-activated stockade lock to prevent an unauthorized person from removing the cables connecting the secure network appliance to the router and user's computer jack. The stockage lock consists of a slidable wedge that can be slid forward under the end of the jack tab to hold it fast in the locking position. The wedge is secured in the locking position by threading down a threaded screw using a unique key formed to fit into a uniquely configured slot on the head of the screw. The secure network appliance encloses the other ends of the connecting cables securely within a hardware container. A physical key is required to open the container and enable insertion of update memory cards in its slots and/or manual updates to be performed by a system administrator or to trigger an automatic Web update.

In a preferred software embodiment, the secure network appliance is run on or operates with a server for a network connected to client computers. The appliance may be a combined server/router, or combined with an upstream router, or combined with a router and modem in an “all in one” appliance. The secure software appliance is locked by a software lock which can only be unlocked a “software key” such as a login passcode by an authorized system administrator. If used in combination with the lockable hardware module, the software key is operable only when the hardware switch is in the “Enable” position. Access with the software key enables the system administrator to access a landing page to perform administrative functions such as assigning approved users ports and updating the whitelists.

The employed whitelist of approved websites lists the web addresses (URLs) or address equivalents of websites that have been recognized as desirable or trustworthy, in effect functioning as a reputation or credibility-based database. Updating a whitelist by adding websites that have acquired the reputation of being desirable or credible is a far simpler and more conveniently performed function than trying to filter out undesirable content from massive volumes of Internet content, or trying to keep up with bad websites that hackers and crooks can create instantaneously.

Other objects, features, and advantages of the present invention will be explained in the following detailed description with reference to the appended drawings.

### BRIEF DESCRIPTION OF DRAWINGS

FIG. 1A is a block diagram showing a conventional web browser system, and FIG. 1B is a block diagram showing a basic embodiment of a whitelist filtering system in accordance with the present invention.

FIG. 2 shows the internal functions of a preferred embodiment of the whitelist filtering system in greater detail.

FIG. 3 illustrates an embodiment of the secure network appliance as a separate hardware component physically interposed between a router and a port of a computer.

FIGS. 4A and 4B show the use of a key-activated stockade lock on jacks of cables that connect the secure network appliance between a router and a computer.

FIGS. 5A and 5B illustrate the secure network appliance in hardware form operable with a keyed-switch, which is shown in the Locked position.

FIGS. 6A and 6B illustrate the hardware appliance in the Open position.

FIGS. 7A and 7B illustrate the secure network appliance in the Update position for enabling updating of its internal whitelist(s).

FIGS. 8A-8D illustrate the various states of the secure network appliance for using updated whitelist(s).

FIGS. 9A and 9B illustrate the secure network appliance implemented in software on a System Server connected between a Router connected to the Internet and wired or wireless Client Computers.

FIG. 10 is a flow chart of the secure network appliance (Slime Box) internal functions.

FIGS. 11A-11C illustrate various system configurations for implementing the secure software appliance on a server network for client computers.

FIG. 12 illustrates a “software key” such as a login passcode required to access the System Server admin page of a secure software appliance.

FIG. 13 illustrates the SysAdmin landing page which provides admin information such as whitelist Updates

### DETAILED DESCRIPTION OF INVENTION

In the following detailed description, certain preferred embodiments are described as illustrations of the invention in a specific application, network, or computer environment in order to provide a thorough understanding of the present invention. Those methods, procedures, components, or functions which are commonly known to persons of ordinary skill in the field of the invention are not described in detail as not to unnecessarily obscure a concise description of the present invention. Certain specific embodiments or examples are given for purposes of illustration only, and it will be recognized by one skilled in the art that the present invention may be practiced in analogous applications or environments and/or with equivalent variations of the illustrative embodiments.

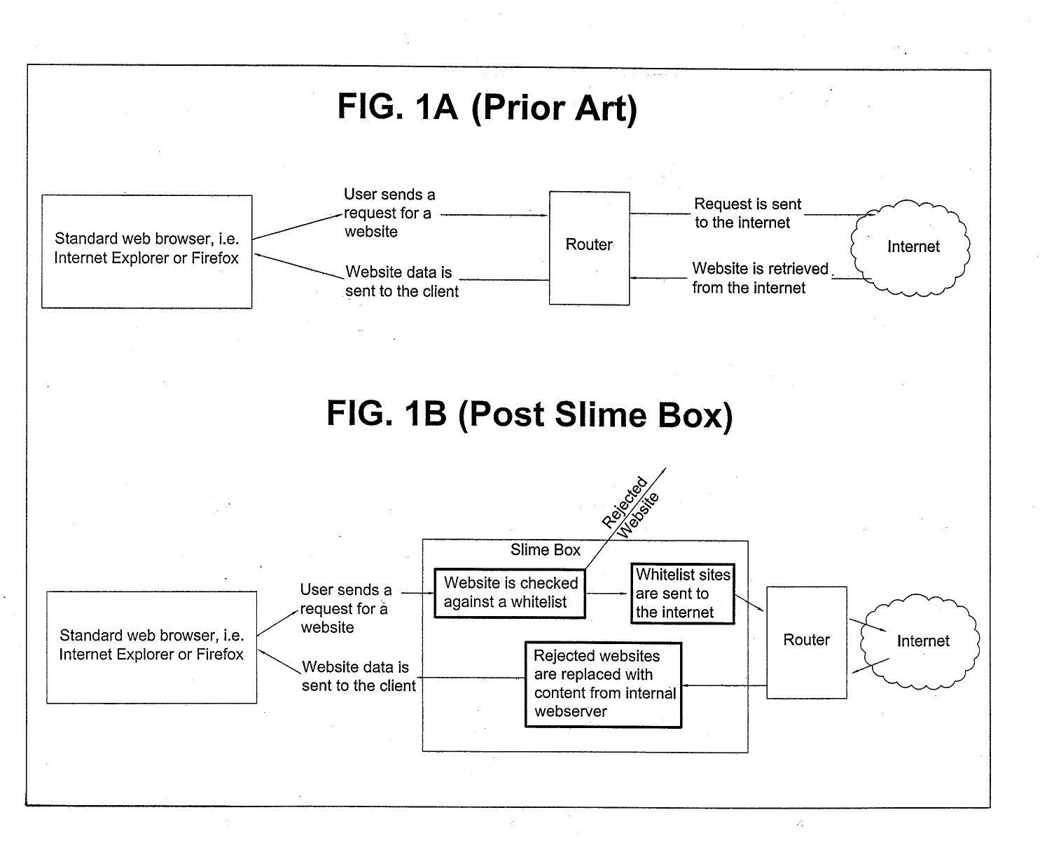

FIG. 1A is a block diagram showing a conventional web browser system for sending requests and receiving pages for websites on the Internet. The browser follows the standard industry protocol for sending user requests for a website and receiving website pages and data through a router which couples it to the Internet. The browser may run with conventional security software for filtering out unwanted websites, malware, spam and adware. Users typically subscribe to a chosen security software that is downloaded to the computer, which needs to be updated frequently for the latest listings of targeted viruses, worms, adware, and malware of all sorts. The security software acts as a filtering device on the computer and includes functions that allow the user to safely navigate websites.

In comparison, FIG. 1B is a block diagram showing a basic embodiment of a whitelist filtering system in accordance with the present invention, sometimes referred to herein by the moniker “Slime Box”. The whitelist filtering system is a secure network appliance interposed between the web browser running on the user's computer and the standard router coupled for communications on the Internet. When the user sends a request for a website, the request passes through the secure network appliance, which first checks against the requested website address against a whitelist of pre-approved websites before the request can be sent on to the router. If the website is not on the whitelist of pre-approved websites, it is rejected, and substitute content is returned to the user from a library of stored content or from replacement content obtained from an internal webserver.

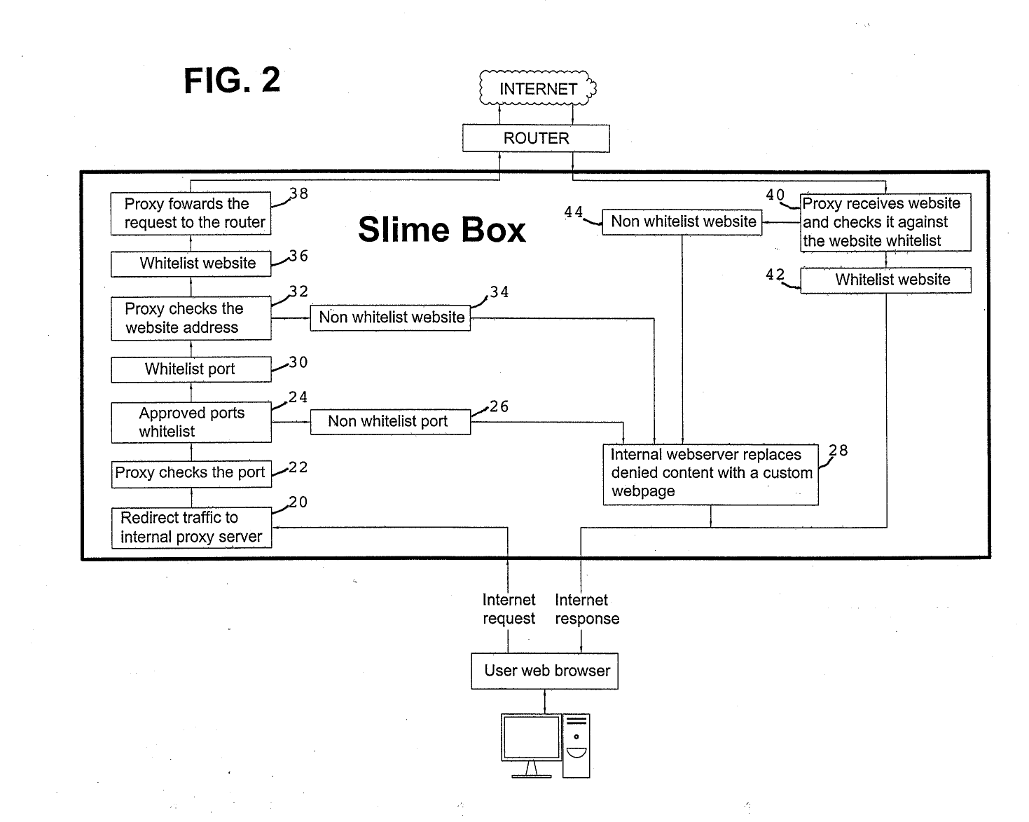

FIG. 2 shows the internal functions of a preferred embodiment of the Slime Box in greater detail. The user's request for a website sent from the user's web browser is first redirected in Block 20 to an internal proxy server. In Block 22, the proxy server checks the port the user's request came through. In Block 24, the detected port for the request is checked against an approved ports whitelist indicated at Block 30. If the port is not on the ports whitelist 30, the request is passed in Block 26 to an internal webserver in Block 28, where it is replaced with pre-arranged content or a custom webpage for rejected port requests and returned as a response to the user's web browser. If the port is on the ports whitelist 30, the proxy server in Block 32 checks the requested website address against an approved websites whitelist indicated at Block 36. If the requested website address is not on the approved websites whitelist 36, the request is passed in Block 34 to the internal webserver in Block 28, where it is replaced with pre-approved content or a custom webpage pre-arranged for rejected website requests and returned as a response to the user's web browser. In Block 38, if the requested website is on the approved websites whitelist, the proxy server forwards the request as output to the router.

The whitelist filtering function may also be performed on the receiving side from the Internet for enhanced security. On receipt of a webpage or data from the Internet through the router, the proxy server in Block 40 checks the received website address against an approved websites whitelist indicated at Block 42. If the sending website address is not on the approved websites whitelist 42, the request is passed in Block 44 to the internal webserver in Block 28, where it is replaced with pre-arranged content or a custom webpage and returned as a response to the user's web browser. If the sending website address is on the approved websites whitelist 42, the proxy server forwards the response to the user's web browser.

The invention works similarly to conventional security software as a filter and Internet content identifier, however, a key difference in the present invention is that the filtering function is contained within a secure network appliance (separately interposed hardware or software component) that employs a whitelist identification system of pre-approved website addresses. The secure network appliance will not allow a user to request or receive any website or website-generated content unless the website address is on the pre-approved white list. The secure network appliance redirects requests to and responses from the Internet through an internal proxy server that will reject any website address that is not on the whitelist and will replace the rejected content with pre-approved content obtained from a library of stored content or from an internal web server accessing approved content to be sent to the user.

The secure network appliance also checks the port that a requests comes through against a pre-approved ports whitelist for enhanced security. Several ports are available on a computer or network system and may typically be used by services other than web browsing, for example, File Transfer Protocol (ftp) is assigned to use port 21. One can enable/disable network services by opening and closing ports, through services like Windows file sharing. In the secure network appliance, a detected port that a request comes from is checked against the approved ports whitelist and, if it is not on the whitelist, the request is rejected and replaced with approved content from an internal webserver. If the request passes the port whitelist, the proxy server will next check the website address against an approved websites whitelist.

The secure network appliance, nicknamed “Slime Box”, may also use only “approved” DNS servers (Domain Name Server) to avoid bogus website addresses. A default approved DNS may be pre-configured and/or be changeable by the system administrator. DHCP or DNS messages are passed from the router to the appliance as with other network services like Xbox, media servers, etc.

The term “routing” generally refers to selecting a data stream path or connection between two endpoints and it can also mean a process to route the whole network or a specific network part. A network is made of connections as links in a chain. If a connection is desired to be protected, two separate routes must be found between endpoints of the connection. The linking of Internet content to the modem, to the router, to the secure network appliance, and to the computer can be thought of in terms of layering. The secure network appliance is connected on the shortest route from the router and closest to the bottom layer of the end user's computer. A first essential link from top to bottom layers is from the signal-receiving modem to the router, which can be configured in a conventional manner to include a blacklist filter of disapproved websites and provide a user with a basic layer of protection. A second essential link connects the router to the secure network appliance in a lower layer just above the bottom layer of the end user's computer for complete protection by only transmitting content/requests to and from the computer for approved website addresses on the whitelist. The position and configuration of the appliance can be customized based on the network topology, whether as a separate component or combined with other network components.

### Secure Hardware Appliance

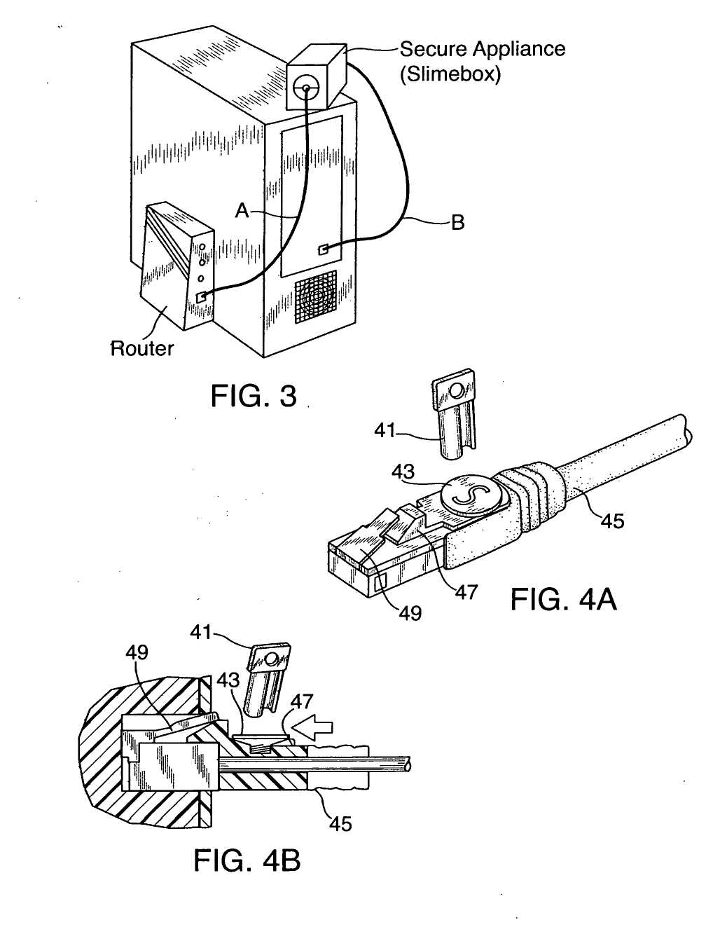

FIG. 3 illustrates the secure network appliance embodied as a separate hardware component that is physically interposed in a location linking a router to a port of a computer. The appliance has a cable A to the router and a cable B to the computer, which may standard types of Ethernet cables. As shown in FIGS. 4A and 4B, the jacks that connect the cables to the router and the computer may have a key-activated stockade lock to prevent an unauthorized person from removing the cables and the secure network appliance from the router and computer, and connecting the router directly to the computer. The plug-in jack on the end of the Ethernet cable 45 has a jack tab 49 which snaps into a locking position behind a locking shoulder when inserted into the plug receptacle for the jack. The stockage lock consists of a slidable wedge 47 that can be slid forward under the end of the jack tab 49 to hold it fast in the locking position. The wedge 47 is secured in the locking position by threading down a threaded screw 43 using a unique key 41 formed to fit into a uniquely configured slot on the head of the screw 43. This locking capability of the connecting cables is designed to be completely controlled by the system administrator who has custody of the unique key. The key allows for easy locking and removal in a tamper-proof system.

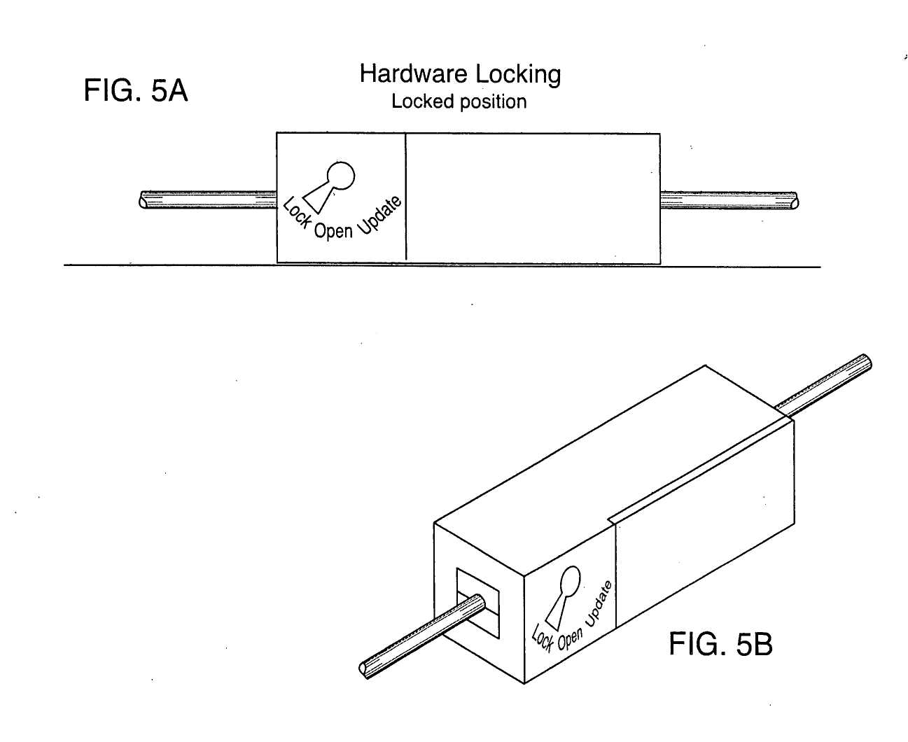

FIGS. 5A and 5B illustrate the secure network appliance in hardware form having the ends of the connecting cables securely enclosed within the hardware container. A physical key is required to operate a switch between Locked, Open, and Update positions. In the Locked position the end panels of the secure network appliance are closed around the cables to completely seal off the internals of the appliance.

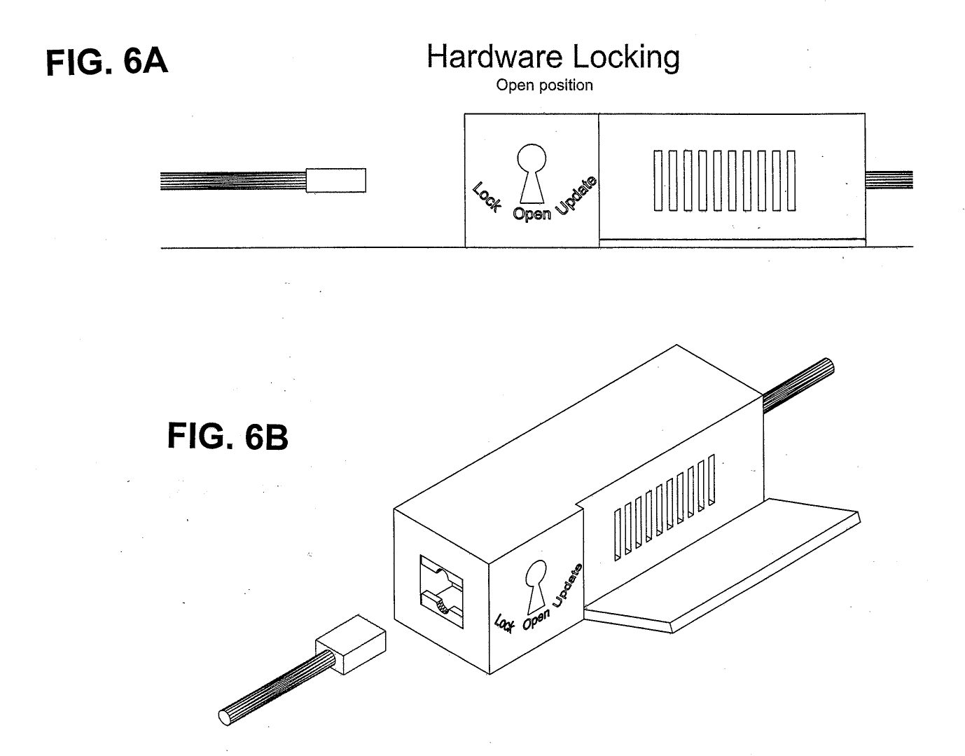

FIGS. 6A and 6B illustrate the secure appliance in the Open position, in which the end panels of the secure network appliance are opened to allow the cables to be removed if desired, and a side panel is opened to expose a number of functional slots/switches.

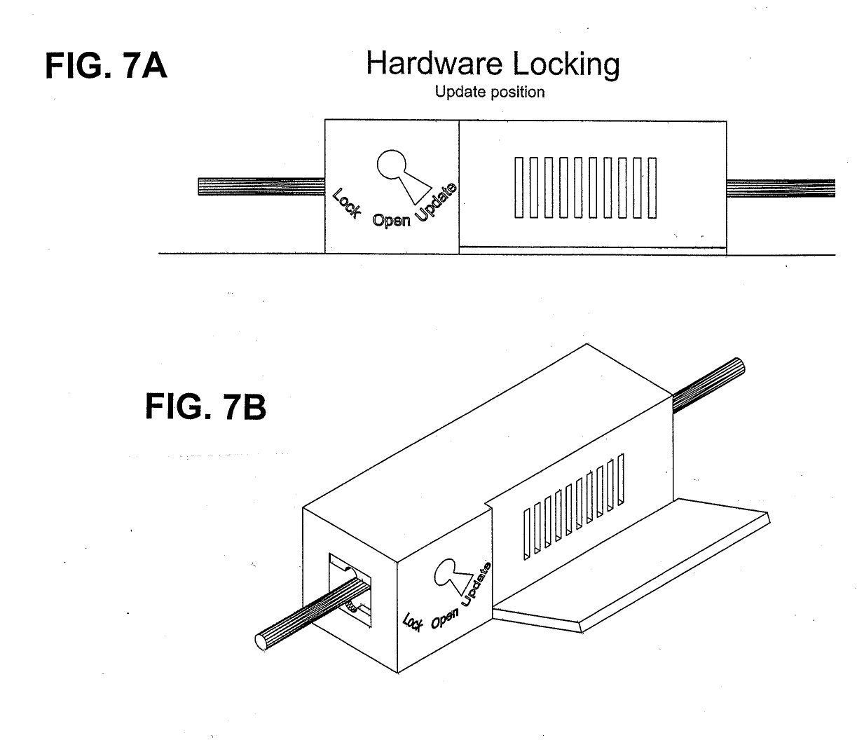

FIGS. 7A and 7B illustrate the secure network appliance in the Update position for enabling updating of its internal whitelist(s) by insertion of flash memory update cards in the slots and/or enabling manual updating by the system administrator from a system server or through authorized Web Updates. The Update cards are prepackaged chip cards that contain current whitelists of approved websites. The chips can be a Micro SD or a custom chip. The slots for the chips are inside the physically locked area. Multiple chips could be inserted for larger whitelists.

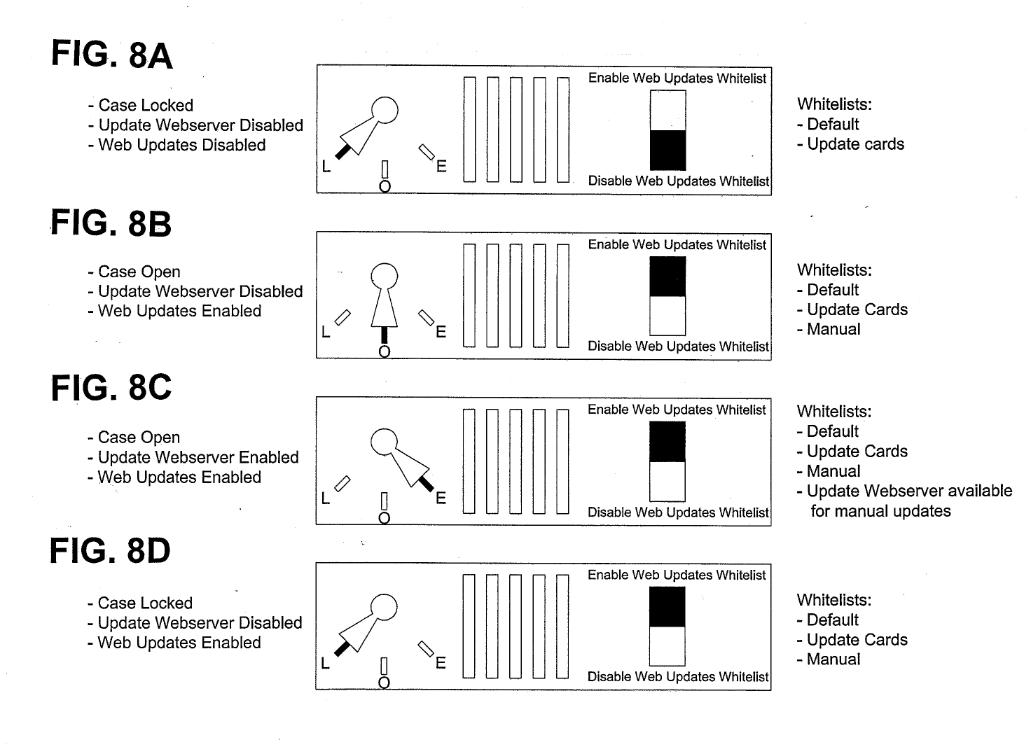

FIGS. 8A-8D illustrate the various states of the secure network appliance for using updated whitelist(s). In FIG. 8A, the hardware switch is in the Locked position, and a switch for Web Updates is in the Disable position, so that updated whitelists can only come from an internal memory as a default list and/or any Update cards inserted in the available card slots. In FIG. 8B, the hardware switch is in the Open position, and the switch for Web Updates is in the Enable position. Web Updates are enabled but the internal webserver for Web updates is not yet enabled. Here updated whitelists can come from the internal default memory, any Update cards inserted in the card slots, and by manual updating of the system administrator from a system server. In FIG. 8C, the hardware switch is in the Enable position and the switch for Web Updates is in the Enable position, which activates an internal webserver to update whitelists from internal default memory, any Update cards in the card slots, and/or by manual updating of the system administrator or by automatically triggering external Web Updates. In FIG. 8D, the hardware switch is again in the Locked position, and the switch for Web Updates remains in the Enable position, so that updated whitelists can come from internal default memory, any Update cards in the card slots, and by manual updating of the system administrator. Locking the case will restart the updating of the system.

For manual updating, user computers plugged into a Management Port can be manually updated by an internal webserver that allows a system administrator to manually enter approved websites for the whitelist. No other computers on other ports can update the whitelist. The Web Updates Whitelist switch must be in the Enable position to allow manually entered websites to be included in the whitelist. If in the Disable position, the appliance will ignore any manually entered list.

### Secure Software Appliance

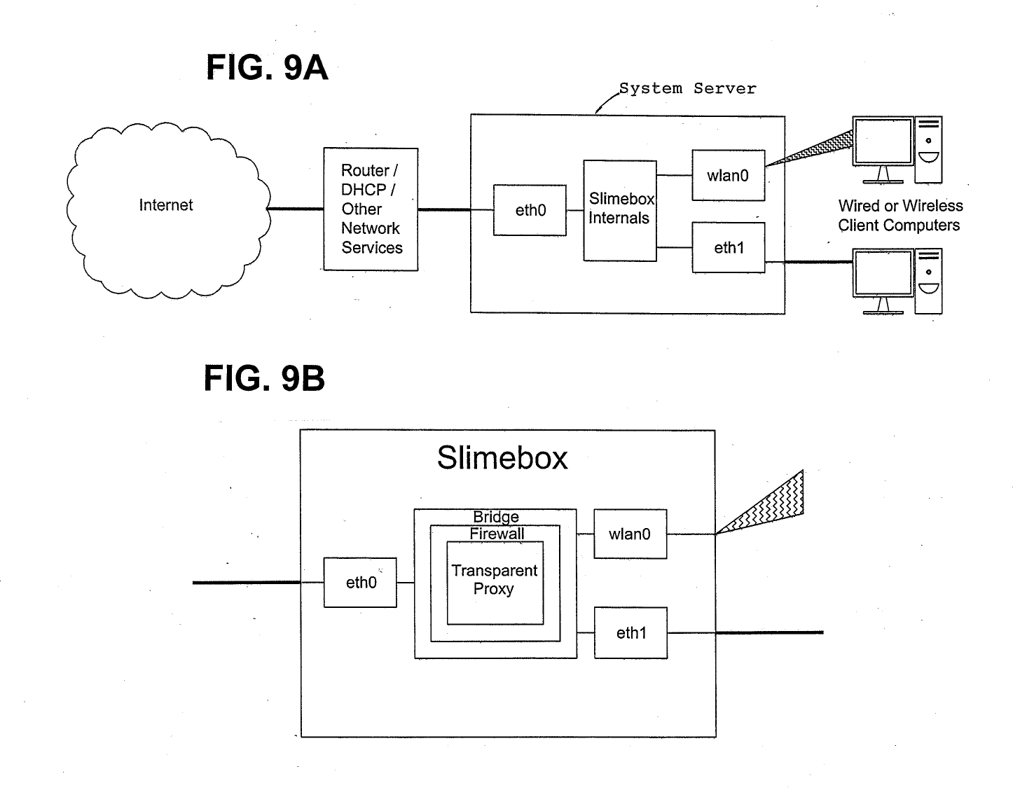

The secure network appliance may be implemented in security software operated by the system administrator for computers connected to an internal or local area network. FIGS. 9A and 9B illustrate the secure network appliance implemented in software to run on or operate with a System Server connected between a Router connected to the Internet and wired or wireless Client Computers. The secure software appliance is encapsulated within a secure containment of a firewall and/or bridge so that only an authorized administrator having a unique key can have access to the internal control functions of the secure network appliance. The secure network appliance (Slime Box) is preferably an internal, transparent proxy server operable within the firewall and bridge, for example, to monitor traffic between an Ethernet port eth0 connected to the Router and outgoing ports wlan0 for a wireless connection and eth1 for a wired connection to users computers.

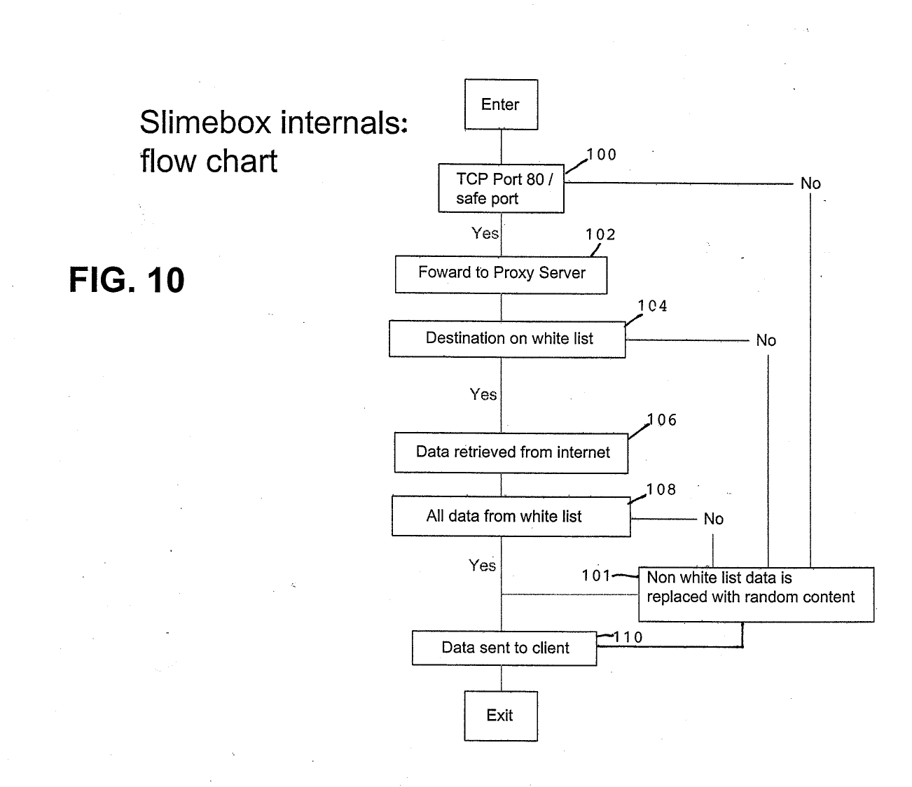

FIG. 10 is a flow chart of the secure network appliance (Slime Box) internal functions upon entry of a request for a website. In Block 100, a check is made whether the request is coming from a safe port. Requests from unsafe ports (dns queries, proxies) are redirected to Block 101 where the content is replaced with other content stored in a library or obtained by an internal webserver from approved websites (“random content”). If it comes from whitelisted safe ports, the request is forwarded to the internal Proxy Server in Block 102. The Proxy Server checks the website address of the request against the whitelist in Block 104. If whitelisted, the request is allowed to pass. If not, it is redirected to Block 101 where the content is replaced with random content. On return of data retrieved from the Internet in response to a request in Block 106, the Proxy Server checks the sending website address of the response against the whitelist in Block 108. If whitelisted, the response is sent to the client as indicated in Block 110. If not, it is redirected to Block 101 where the content is replaced with random content.

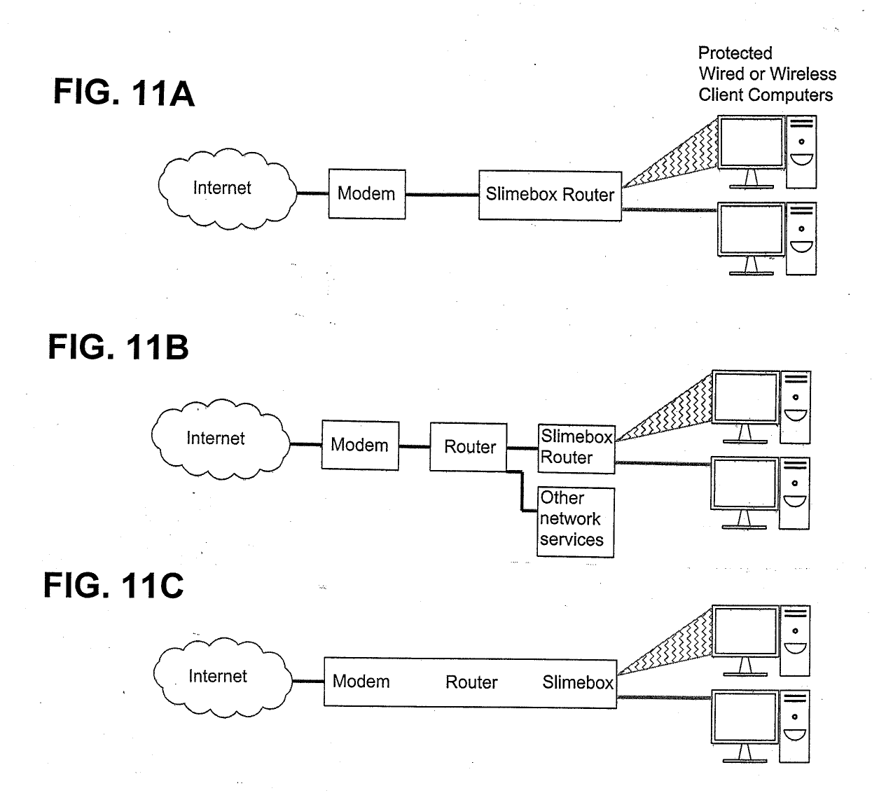

FIGS. 11A-11C illustrate various system configurations for implementing the secure software appliance on a server network for client computers. FIG. 11A shows the secure network appliance (Slime Box) as a server combined with a network router between a modem connected to the Internet and the client computers. As a combined server/router, all client requests would be blocked unless an approved client port is established. FIG. 11B shows the secure network appliance as a server combined with a router between an upstream Router and modem connected between the Internet and the client computers. FIG. 11C shows the secure network appliance as a server combined with a router and modem connected between the Internet and the client computers. The “all in one” appliance can be used as a complete policy-based routing system, in which all routing decisions are based on policies set by the network administrator.

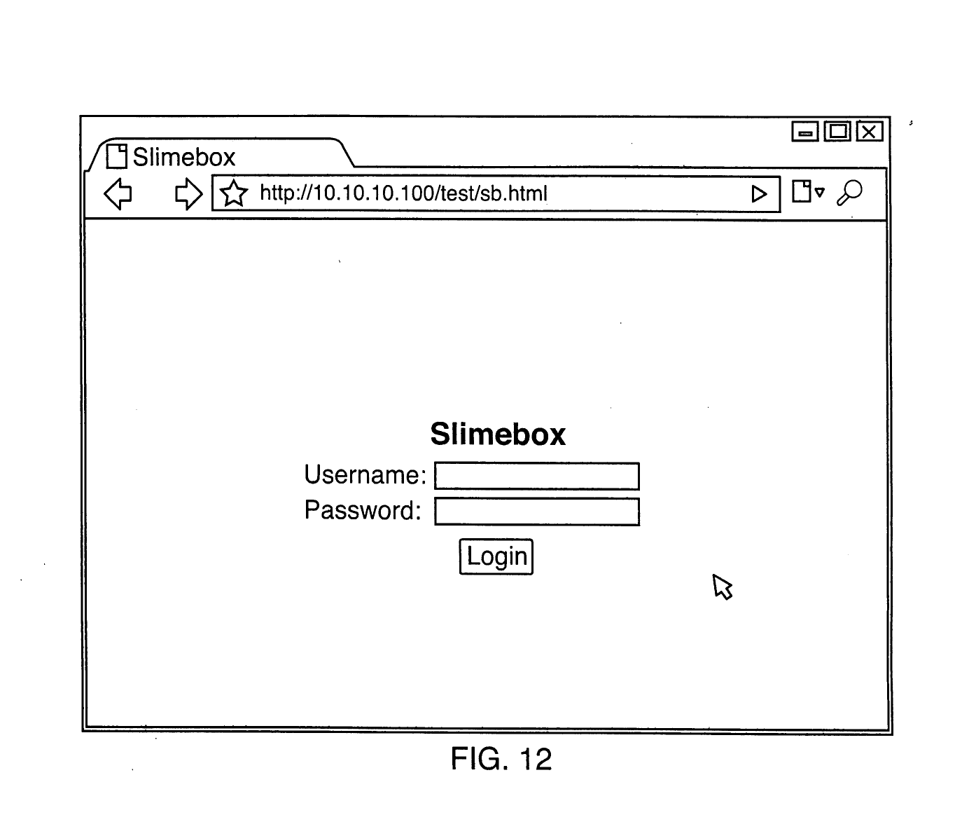

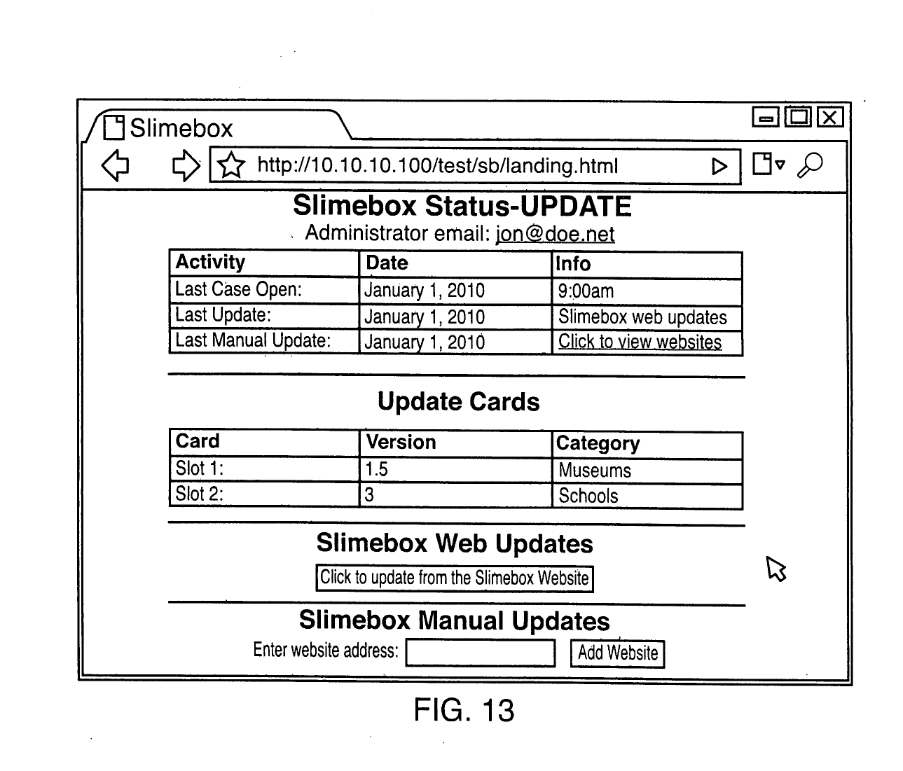

The secure software appliance is locked by a software lock which can only be unlocked by an authorized system administrator (SysAdmin). If used in combination with the lockable hardware module, the software key is operable only when the hardware switch is in the “Enable” position. The SysAdmin can configure the system's network ports that connect to computers of users. Once the administrator sets the network port settings, users cannot change these settings. This prevents a user from connecting to another Internet connection, such as an open Wi-Fi hotspot, while on the network. As illustrated in FIG. 12, a “software key” such as a login passcode is required to access the System Server admin page. FIG. 13 illustrates the SysAdmin landing page which provides admin information and enables the SysAdmin to perform administrative functions such as assigning approved users ports, and enabling whitelist Updates, Update Cards, Web Updates, and Manual Updates. Memory cards can also be individually enabled or disabled.

In summary, the secure whitelist appliance provides a realtime check of all Internet communications from and to user or client computer(s). Any website addresses requested or sending response data not specifically on the whitelist gets rejected or replaced with approved content. This includes but is not limited to: website domains, ports, and virus activity. The appliance is secured by hardware or software locking. The secure network appliance improves the rate and efficiency of Internet communication with its port blocking capabilities that effectively disable memory taxing software, and frees the operating system while securing it from being hacked. In contrast to the known approaches of filtering software using continually updated blacklists to block or filter out myriads of instantaneously created non-conforming or bogus websites, the secure network appliance can much more efficiently pass only approved websites and reject all others. This provides an inherently powerful and 100% filter control solution in an environment where hackers can instantaneously change their source address or apparent identity.

It is understood that many modifications and variations may be devised given the above description of the principles of the invention. It is intended that all such modifications and variations be considered as within the spirit and scope of this invention, as defined in the following claims.

1. A secure network appliance for filtering requests for websites on the Internet sent from, and Internet responses received to, a user's web browser on a computer, comprising: a whitelist checking means for checking each user request sent from the user's web browser to a web address for a website on the Internet against a whitelist of web addresses of pre-approved websites and passing the request to the Internet only if the requested web address is on the whitelist; and containing means for encapsulating the secure network appliance within a secure container so that only an authorized administrator having a unique key can unlock the containing means and have access to control functions of said secure network appliance.

2. A secure network appliance according to claim 1, wherein if the requested website address is not on an approved websites whitelist, the request is replaced with pre-arranged content and returned as a response to the user's web browser.

3. A secure network appliance according to claim 1, wherein said whitelist checking means also checks the port the user's request came through against an approved ports whitelist, and if the port is not on an approved ports whitelist, the request is replaced with pre-arranged content and returned as a response to the user's web browser.

4. A secure network appliance according to claim 1, wherein said whitelist checking means also checks each response sent from a website on the Internet, and if a sending web address for the website is not on an approved websites whitelist, the response is replaced with pre-arranged content and passed to the user's web browser.

5. A secure network appliance according to claim 1 formed as a separate hardware component that is physically interposed in a location linking a router to a port of a user's computer, and having a secure hardware container enclosing its internal functioning components and ends of cables connecting said secure network appliance to the router and to the user's computer.

6. A secure network appliance according to claim 5, wherein said secure hardware container is openable by a unique physical key to enable access to its internal functioning components and ends of cables connecting said secure network appliance to the router and to the user's computer.

7. A secure network appliance according to claim 5, wherein the other ends of the cables connecting to the router and to the user's computer have lockable jacks provided with a key-activated lock to prevent an unauthorized person from removing the cables from the router and the user's computer.

8. A secure network appliance according to claim 7, wherein said lockable jacks have a stockage lock consisting of a slidable wedge that can be slid forward under the end of the jack tab to hold it fast in the locking position, and is secured in the locking position by threading down a threaded screw using a unique key formed to fit into a uniquely configured slot on the head of the screw.

9. A secure network appliance according to claim 5, wherein said secure hardware container contains slots for insertion of update memory cards and a switch to enable manual updates of the whitelist to be performed by a system administrator or to trigger an automatic Web update.

10. A secure network appliance according to claim 1 formed as a secure software embodiment that run on or operates with a server for a network connected to client computers.

11. A secure network appliance according to claim 10, wherein said secure network appliance formed as a secure software embodiment runs on or is operable in one of the group of network configurations consisting of: a combined server/router; combined with an upstream router; and combined with a router and modem in an “all in one” appliance.

12. A secure network appliance according to claim 10, wherein said secure network appliance formed as a secure software embodiment is locked by a software lock which can only be unlocked a software key used by an authorized system administrator.

13. A secure network appliance according to claim 10, wherein said secure network appliance formed as a secure software embodiment, upon access with the software key, provides a landing page for the system administrator to perform administrative functions such as assigning approved users ports and updating the whitelists.

14. A method of filtering requests for websites on the Internet sent from, and Internet responses received to, a user's web browser on a computer, comprising: providing checking means for checking each user request sent from the user's web browser to a web address for a website on the Internet against a whitelist of web addresses of pre-approved websites and passing the request to the Internet only if the requested web address is on the whitelist; and encapsulating the checking means within a secure container so that only an authorized administrator having a unique key can unlock the secure container and have access to control functions for the checking means therein.

15. A method of filtering requests for websites according to claim 14, wherein if the requested website address is not on an approved websites whitelist, the request is replaced with pre-arranged content and returned as a response to the user's web browser.

16. A method of filtering requests for websites according to claim 14, wherein said checking means also checks the port the user's request came through against an approved ports whitelist, and if the port is not on an approved ports whitelist, the request is replaced with pre-arranged content and returned as a response to the user's web browser.

17. A method of filtering requests for websites according to claim 14, wherein said checking means also checks each response sent from a website on the Internet, and if a sending web address for the website is not on an approved websites whitelist, the response is replaced with pre-arranged content and passed to the user's web browser.

18. A method of filtering requests for websites according to claim 14, wherein said secure container is formed as a separate hardware component that is physically interposed in a location linking a router to a port of a user's computer.

19. A method of filtering requests for websites according to claim 14, wherein said secure container is formed as a secure software embodiment that run on or operates with a server for a network connected to client computers.

20. A method of filtering requests for websites according to claim 19, wherein said secure software embodiment runs on or is operable in one of the group of network configurations consisting of: a combined server/router; combined with an upstream router; and combined with a router and modem in an “all in one” appliance.
